(19) United States
(12) Patent Application Publication
(10) Pub. No.: US 2019/0064121 A1
(43) Pub. Date: Feb. 28, 2019

(54) ACOUSTIC WAVE RECEIVING APPARATUS

(71) Applicant: CANON KABUSHIKI KAISHA, Tokyo (JP)

(72) Inventor: Takaaki Nakabayashi, Kawasaki-shi (JP)

(21) Appl. No.: 16/112,324

(22) Filed: Aug. 24, 2018

(30) Foreign Application Priority Data
Aug. 31, 2017 (JP) 2017-167249

(51) Int. Cl. G01N 29/28; G01N 29/06; G01N 29/22

(52) U.S. Cl. CPC G01N 29/28; G01N 29/225; G01N 29/0654

(57) ABSTRACT

An acoustic wave receiving apparatus includes a liquid vessel for storing an acoustic matching liquid and a receiving unit for receiving an acoustic wave from a subject via the acoustic matching liquid, wherein the liquid vessel includes a drainage port for discharging the acoustic matching liquid, an annular portion surrounding the drainage port, a peripheral portion located outside the annular portion, and a drainage acceleration unit for accelerating drainage of the acoustic matching liquid from the peripheral portion toward the annular portion.

### BACKGROUND OF THE INVENTION

### Field of the Invention

The present disclosure relates to an acoustic wave receiving apparatus including a liquid vessel which stores an acoustic matching liquid for acoustically coupling a receiving unit and a subject.

### Description of the Related Art

An acoustic wave receiving apparatus is known which includes a receiving unit provided with a plurality of probes for receiving an acoustic wave from a subject and obtains an acoustic wave image of the subject by receiving the acoustic wave from the subject via an acoustic matching liquid stored in a liquid vessel.

Japanese Patent Application Laid-Open No. 2016-55159 describes an acoustic wave receiving apparatus which obtains a photoacoustic image of a breast as a subject by irradiating the subject with near-infrared light and receiving an acoustic wave generated in the subject. The acoustic wave receiving apparatus described in Japanese Patent Application Laid-Open No. 2016-55159 includes a supporting base which supports a subjectee and has an insertion port and a liquid vessel which stores an acoustic matching liquid to a liquid level at which a subject inserted from the insertion port can be acoustically coupled to the receiving unit.

Japanese Patent Application Laid-Open No. 2016-55159 further describes that a water supply and drainage port is disposed on a bottom of the liquid vessel for supplying and discharging water as the acoustic matching liquid into and from the liquid vessel.

### SUMMARY OF THE INVENTION

In the acoustic wave receiving apparatus described in Japanese Patent Application Laid-Open No. 2016-55159, the acoustic matching liquid not reaching the drainage port may remain as a residue in the liquid vessel in some cases even when drainage control of the acoustic matching liquid is performed by control of a water supply and drainage system. The acoustic matching liquid remaining in the liquid vessel may denature and deteriorate an acoustic characteristic as time passes and may accumulate as an ion deposit on an inner wall of the liquid vessel and a receiving surface of a probe, and thus reception characteristics of the acoustic wave receiving apparatus may be deteriorated. In addition, there is a risk that the acoustic matching liquid remaining in the liquid vessel may deteriorate hygiene in a measurement environment in some cases.

An acoustic wave receiving apparatus according to the present disclosure includes a liquid vessel configured to store an acoustic matching liquid and a receiving unit configured to receive an acoustic wave from a subject via the acoustic matching liquid, wherein the liquid vessel includes a drainage port configured to drain the acoustic matching liquid, an annular portion surrounding the drainage port, and a peripheral portion located outside the annular portion, and wherein the liquid vessel is configured to accelerate drainage of the acoustic matching liquid from the peripheral portion toward the annular portion.

Further features of the present disclosure will become apparent from the following description of exemplary embodiments with reference to the attached drawings.

### BRIEF DESCRIPTION OF THE DRAWINGS

FIG. 1A is a cross-sectional view of an acoustic wave receiving apparatus, and FIG. 1B is a plan view of a liquid vessel according to a first exemplary embodiment.

FIG. 2A is a cross-sectional view of an acoustic wave receiving apparatus, and FIG. 2B is a plan view of a liquid vessel according to a reference exemplary embodiment.

FIGS. 3A to 3D illustrate solid-liquid contact angles of an acoustic matching liquid when solid surfaces are different.

FIG. 4 is a cross-sectional view of a liquid vessel according to a modification of the first exemplary embodiment.

FIG. 5A is a cross-sectional view of an acoustic wave receiving apparatus provided with a wiper, and FIG. 5B is a plan view of a liquid vessel according to a second exemplary embodiment.

FIGS. 6A and 6B are cross-sectional views of an acoustic wave receiving apparatus provided with a blower according to a third exemplary embodiment.

FIG. 7 is a cross-sectional view of an acoustic wave receiving apparatus provided with a vibration mechanism according to a fourth exemplary embodiment.

### DESCRIPTION OF THE EMBODIMENTS

Various exemplary embodiments for implementing the present disclosure will be described below with reference to the attached drawings. The present exemplary embodiment is a photoacoustic wave receiving apparatus which irradiates a subject with light and captures an image of the subject by receiving an acoustic wave generated from the subject. A photoacoustic wave receiving apparatus is described here, however, the present disclosure can be applied to an acoustic wave transmitting and receiving apparatus which transmits an acoustic wave and receives a reflected wave and a scattered wave from a subject.

### <Basic Configuration of Acoustic Wave Receiving Apparatus>

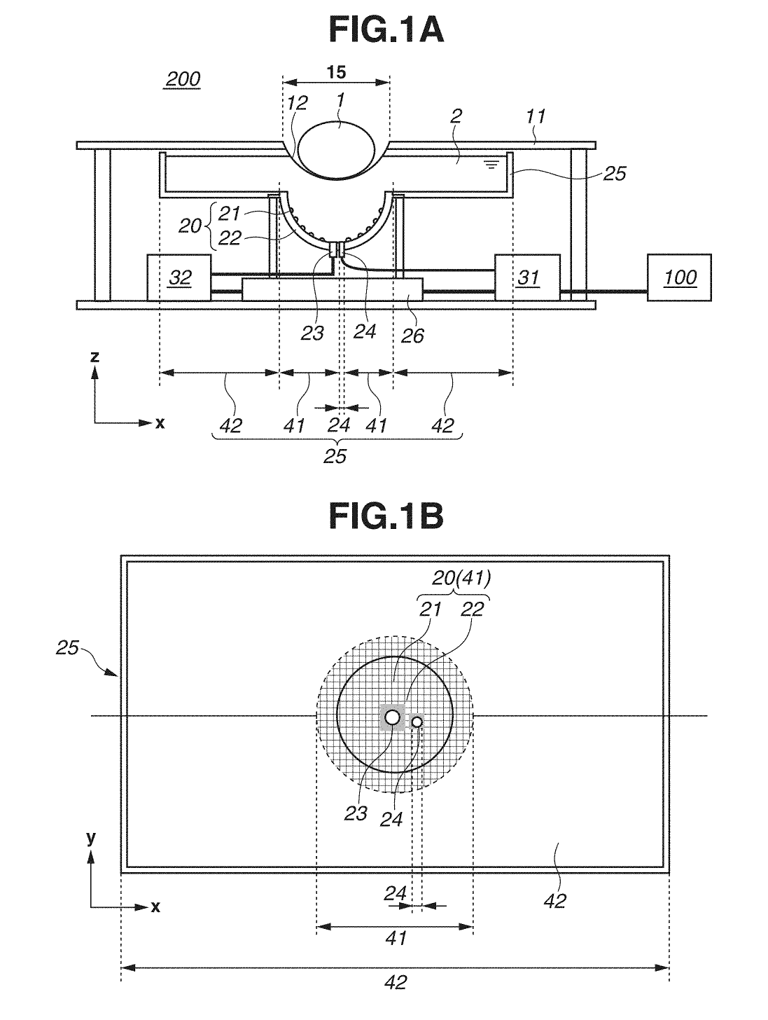

First, a basic configuration of an acoustic wave receiving apparatus 200 according to a first exemplary embodiment is described. FIG. 1A is a cross-sectional schematic view of the acoustic wave receiving apparatus 200 which can receive a photoacoustic wave from a subject and create an image of biological information pieces such as distribution of a specific component like blood hemoglobin and melanin and running distribution of blood vessels.

A supporting unit 11 is a supporting base which is extended along an approximately horizontal plane (an xy plane) and on which a subjectee not illustrated can take an imaging posture in a prone position. The supporting unit 11 is provided with an insertion port 15 into which a subject 1, namely a part of a subjectee is inserted, and a cup-shaped holding member 12 for holding the subject 1 is fixed thereto at a position overlapping with the insertion port 15. The insertion port 15 is disposed on the supporting unit 11 so as to include an upper limb, a lower limb, a head, a breast, and others of a subjectee as an imaging target.

The holding member 12 is constituted of an acoustic matching material having a propagation characteristic (low attenuation performance) of an acoustic wave so that the receiving unit 20 receives an acoustic wave propagated from the subject 1, and resin materials such as isoprene rubber (IR), silicone rubber, and polyethylene terephthalate which transmit light in an infrared range is applied. In addition, it is desirable that the holding member 12 has sealing performance for separating spaces so that an acoustic matching liquid 2 stored in a liquid vessel 25 describe below does not directly contact with the subject 1. The sealing performance of the holding member 12 can ensure hygiene of the acoustic matching liquid 2 stored in the liquid vessel 25.

The liquid vessel 25 includes the receiving unit 20 for receiving an acoustic wave propagated from the subject 1. In the receiving unit 20, a plurality of transducers 21 is supported by a bowl-shaped supporting member 22 (an annular portion 41) in a predetermined array.

The liquid vessel 25 includes a light irradiation unit 23 for irradiating the subject 1 with light on a bottom of the supporting member 22 (the annular portion 41). The light irradiation unit 23 is optically coupled to a light source 32 via an optical fiber. The optical fiber guides light emitted from the light source 32 to the light irradiation unit 23.

The liquid vessel 25 further includes an annular bank portion so as to be able to store the acoustic matching liquid 2 for acoustically coupling the subject 1 and the transducer 21 via the holding member 12 to at least a liquid level higher than a lowest point of the holding member.

The liquid vessel 25 furthermore includes a supply and drainage port 24 which enables supply and drainage of the acoustic matching liquid 2 so as to cope with change and rising and falling of the liquid level of the acoustic matching liquid. The supply and drainage port 24 is disposed side by side with the light irradiation unit 23 on a bottom of the bowl-shaped supporting unit 11. The supply and drainage port 24 is connected to a supply and drainage unit 31 including a pump and a gate valve, which are not illustrates, for controlling a supply amount and a drainage amount of the acoustic matching liquid 2 via a pipe. Supply and drainage of the acoustic matching liquid 2 is controlled by the supply and drainage unit 31. The supply and drainage unit 31 according to the present exemplary embodiment may include a reservoir tank not illustrated for storing the acoustic matching liquid 2. The supply and drainage port 24 may serve as a drainage port through which the acoustic matching liquid 2 is not supplied by providing a supply port not illustrated.

The liquid vessel 25 is connected to a two-dimensional scanning stage 26, and the receiving unit 20 and the light irradiation unit 23 are integrally and two-dimensionally scanned by the two-dimensional scanning stage 26 in an approximately horizontal plane. Thus, it can be reworded that the receiving unit 20 and the light irradiation unit 23 are integrally and two-dimensionally scanned by the two-dimensional scanning stage 26 relatively with respect to the holding member 12 or the subject 1.

The two-dimensional scanning stage 26 is configured to be able to two-dimensionally scan the receiving unit 20 and the light irradiation unit 23 using an arbitrary two-dimensional scanning pattern including rotary scanning, helical scanning, and raster scanning.

A driving operation of the photoacoustic wave receiving apparatus including the supply and drainage unit 31 and the two-dimensional scanning stage 26 is performed by an operation unit 100. The operation unit 100 includes an operation panel and a monitor for monitoring an imaging situation, which are not illustrated, and a user can input an operation on the apparatus using the operation panel while watching the monitor.

### <Imaging Sequence>

Next, an outline of imaging sequences according to the present exemplary embodiment is described.

As a preparation before imaging, the acoustic matching liquid 2 is supplied to the liquid vessel 25 by control of the supply and drainage unit 31 to a liquid level at which the receiving unit 20 and the holding member 12 can be acoustically coupled to each other. It is desirable that the liquid level of the acoustic matching liquid 2 is set as high as possible to increase a contact area between the holding member 12 having a curved cup shape and the acoustic matching liquid 2. An aspect of the present disclosure includes a configuration in which a liquid level sensor is installed inside the liquid vessel 25 to monitor the liquid level of the acoustic matching liquid 2 and a configuration which can predict the liquid level from a relationship between a supply time and a supply speed of the acoustic matching liquid 2 into the vessel.

When it is determined that the acoustic matching liquid 2 is supplied to the liquid level at which the holding member 12 is sufficiently acoustically coupled, next, the subject 1 is placed on the holding member 12, and the holding member 12 holds the subject 1. It is desirable to supply an acoustic matching material including water and gel in the cup-shaped holding member 12 to obtain acoustic matching between the subject 1 and the holding member 12. A timing to supply the acoustic matching material in the holding member 12 may be any timing before an imaging process for receiving an acoustic wave and may be before, after, or the same time when the subject I is placed on the holding member 12.

Next, imaging is started by operating the operation unit 100. When imaging is started, the subject 1 is irradiated with light, the two-dimensional scanning stage 26 two-dimensionally scans the liquid vessel 25, and the receiving unit 20 receives an acoustic wave propagated from the subject 1.

After completing reception of a photoacoustic wave corresponding to a predetermined region of interest with respect to the subject 1, the subject 1 is withdrawn from the holding member 12. As a procedure after imaging, an imaging engineer wipes away the acoustic matching material attached to the subject 1 as necessary.

After imaging, the supply and drainage unit 31 is driven, and the acoustic matching liquid 2 in the liquid vessel 25 is drained.

<Drainage Acceleration of Acoustic Matching Liquid from Liquid Vessel>

The acoustic wave receiving apparatus 200 according to the present exemplary embodiment is provided with a drainage acceleration unit for accelerating drainage of the acoustic matching liquid 2 from a peripheral portion 42 to the annular portion 41 to solve the issue that an acoustic matching liquid 2a remains inside of the liquid vessel 25 by surface tension and cannot be completely drained (hereinbelow, the acoustic matching liquid 2 remaining in the liquid vessel 25 is referred to as a residual acoustic matching liquid 2a).

More specifically, the acoustic wave receiving apparatus 200 according to the present exemplary embodiment accelerates a flow of the acoustic matching liquid 2 from the peripheral portion 42 located outside the annular portion 41 toward the annular portion 41 surrounding the drainage port 24 and reduces the acoustic matching liquid 2a remaining in the peripheral portion 42.

FIG. 1A is a cross-sectional view of the acoustic wave receiving apparatus 200 viewed from a y direction when a vertical direction is regarded as a z direction. FIG. 1B is a plan view illustrating the drainage port 24, the annular portion 41, and the peripheral portion 42 of the acoustic wave receiving apparatus 200 according to the first exemplary embodiment when the liquid vessel 25 is viewed from above in the vertical direction. The annular portion 41 corresponds to a latticed hatching portion in FIG. 1B and corresponds to a portion overlapping with the receiving unit 20 arranged in an array including a plurality of the transducers 21 supported by the hemispherical supporting member 22. The annular portion 41 is surrounded by the peripheral portion 42 via an annular boundary, and in other words, the drainage port 24 is disposed in a non-arrangement area inside the annular boundary in which the transducers 21 are not arranged.

On the other hand, the peripheral portion 42 corresponds to a portion located outside the annular portion 41 in the liquid vessel 25 in FIG. 1B and occupies the majority of a storage portion of the acoustic matching liquid 2. In other words, the peripheral portion 42 corresponds to a drainage area when the portion dominantly storing the acoustic matching liquid 2 in a bottom surface of the liquid vessel 25 is projected on the horizontal plane.

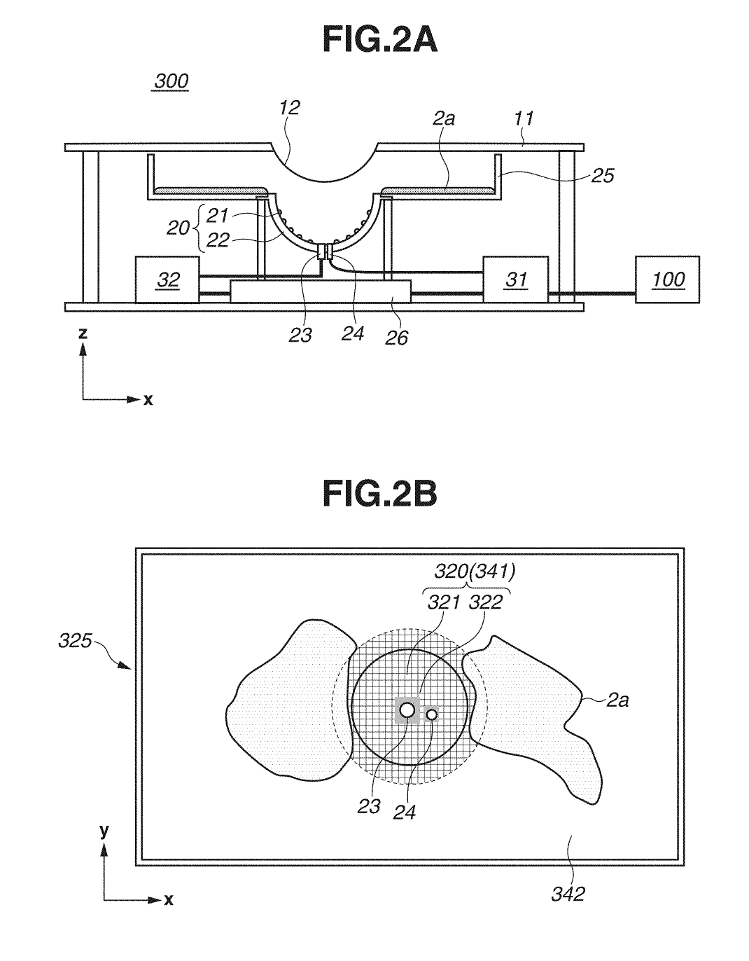

A reference exemplary embodiment illustrated in FIGS. 2A and 2B is different from the first exemplary embodiment in that an affinity for the acoustic matching liquid 2 is equal between an annular portion 341 surrounding a drainage port 24 and a peripheral portion 342 located outside an annular area or higher in the peripheral portion 342. The peripheral portion 342 corresponds to a portion dominantly storing the acoustic matching liquid in a bottom surface of a liquid vessel 325 as with the peripheral portion 42. In other words, the peripheral portion 342 is larger than the annular portion 341 in an area coming into contact with the acoustic matching liquid 2. Thus, when the affinity for the acoustic matching liquid 2 of the peripheral portion 342 is relatively higher than or equal to that of the annular portion 341, the acoustic matching liquid 2 may be remain as a residue 2a as illustrated in FIGS. 2A and 2B.

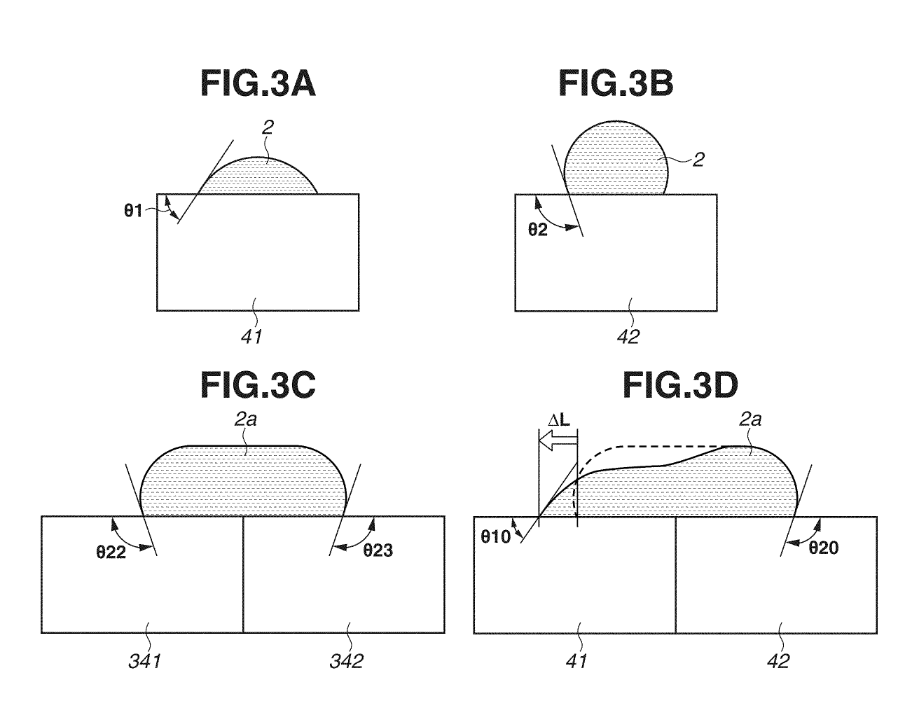

The liquid vessel 25 of the acoustic wave receiving apparatus 200 according to the first exemplary embodiment is described in detail below. A drainage acceleration effect of the acoustic matching liquid according to the present exemplary embodiment is described with reference to FIGS. 3A to 3D.

FIGS. 3A and 3B are cross-sectional schematic views illustrating the annular portion 41 having a relatively high affinity for the acoustic matching liquid 2 and the peripheral portion 42 having a relatively low affinity for the acoustic matching liquid 2 and respective solid-liquid contact angles θ1 and θ2. The solid-liquid contact angle θ1 (<θ2) is formed on the annular portion 41 which is lower than that on the peripheral portion 42.

On the other hand, FIG. 3C is a cross-sectional schematic view of a solid-liquid interface in a state in which the acoustic matching liquid 2a exists on a boundary between the peripheral portion 342 and the annular portion 341 as a liquid pool and corresponds to the reference exemplary embodiment illustrated in FIG. 2B. In this state, a solid-liquid contact angle θ22 of the acoustic matching liquid 2a on a side adjacent to the drainage port 24 is equal to or larger than a solid-liquid contact angle θ23 on a side away from the drainage port 24. The acoustic matching liquid 2a illustrated in FIG. 3C has a weak force to wet and spread from the peripheral portion 342 to the annular portion 341 and easily remains on the boundary between the peripheral portion 342 and the annular portion 341.

On the other hand, FIG. 3D is a cross-sectional schematic view of a solid-liquid interface in a state in which the acoustic matching liquid 2 exists on a boundary between the peripheral portion 42 and the annular portion 41 and corresponds to a drainage process of the acoustic matching liquid according to the first exemplary embodiment illustrated in FIGS. 1A and 1B. In this state, a solid-liquid contact angle θ10 of the acoustic matching liquid 2 on a side adjacent to the drainage port 24 is lower than a solid-liquid contact angle θ20 on a side away from the drainage port 24. On the acoustic matching liquid 2 illustrated in FIG. 3D, a gradient of an interfacial tension is generated in a direction from the peripheral portion 42 to the annular portion 41 at a length corresponding to a difference ΔL so as to easily wet and spread, and a driving force for wetting and spreading the acoustic matching liquid 2 is generated to a side toward the drainage port 24.

The liquid vessel 25 according to the present exemplary embodiment is characterized in that a difference is imparted to the affinity for the acoustic matching liquid 2 of the annular portion 41 overlapping with the receiving unit 20 and that of the peripheral portion 42 storing the majority of the acoustic matching liquid 2 as a drainage acceleration unit. In other words, the liquid vessel 25 according to the present exemplary embodiment has a configuration in which the affinity for the acoustic matching liquid 2 is higher in the annular portion 41 than the peripheral portion 42 to accelerate the drainage of the acoustic matching liquid 2. Having the higher affinity for the acoustic matching liquid 2 can be reworded as that wettability to the acoustic matching liquid 2 is high, a solid-liquid contact angle is low, and surface tension of a supporting solid is high. As described above, when the affinity for the acoustic matching liquid 2 is higher in the annular portion 41 than the peripheral portion 42, a driving force to flow a direction from the annular portion 41 to the peripheral portion 42 is applied to the acoustic matching liquid 2 in the drainage process located across the annular portion 41 and the peripheral portion 42.

When the acoustic matching liquid 2 mainly includes water, it can be reworded as that the annular portion 41 has a higher hydrophilic property than the peripheral portion 42.

A solid material having large surface tension can be reworded as a material having large binding energy between constituting atoms in crystallographic terms. As a broad trend, binding energy generally becomes smaller in an order of a covalent bond, an ionic bond, and a metallic bond. Thus, rather than a pure metal and an alloy including Ag, Cu, and Al, a carbide, an oxide, a nitride, and the like of these metals and their alloys have higher surface tension.

A solid material having large surface tension can be said as a material having a high elastic constant and high modulus of rigidity in material engineering terms. This fact corresponds to a fact that a ceramic material and a glass material have higher elastic constants than a metal having ductility and malleability. When a surface is formed by a thin film 1E-6 m (1 μm) thick or less, an elastic modulus of a supporting layer which supports the thin film and is thicker than the thin film may be used as a representative value to form distribution of the surface tension.

A highly hydrophilic solid material is understood to include many hydrophilic groups such as H and OH or include few hydrophobic groups such as hydrocarbon expressing a hydrophobic property on a surface composition. Further, a highly hydrophilic solid material is understood to include many materials forming hydrates in a surface material.

Thus, it is desirable that the annular portion 41 includes a material having higher binding energy than the peripheral portion 42 on its surface. Similarly, when the annular portion 41 and the peripheral portion 42 include similar metallic elements, an oxide surface concentration of the annular portion 41 is set higher than that of the peripheral portion 42, and thus the annular portion 41 has surface tension higher than that of the peripheral portion 42.

When the annular portion 41 has a thin film 1E-6 m thick or less on the surface, it is desirable to set elasticity of the supporting member 22 supporting the thin film higher in the annular portion 41. When the annular portion 41 has the thin film 1E-6 m thick or less on the surface and is supported by a material of which elasticity is lower than that of the thin film, a thickness of the material supporting the supporting member 22 may be reduced, and thus the supporting member 22 has surface tension higher than that of the peripheral portion 42.

When liquid composition of the acoustic matching liquid is mainly composed of water, a surface concentration of a hydrophilic group of the annular portion 41 may be set higher than that of the peripheral portion 42, and thus the annular portion 41 has a higher hydrophilic property than that of the peripheral portion 42. Similarly, when the liquid composition of the acoustic matching liquid is mainly composed of water, surface concentration of a hydrate forming material of the annular portion 41 may be set higher than that of the peripheral portion 42, and thus the annular portion 41 has a higher hydrophilic property than that of the peripheral portion 42. A hydrate forming material includes aluminum oxide (alumina), chromium oxide, titanium oxide, and the like. In other words, when liquid composition of the acoustic matching liquid is mainly composed of water is that the acoustic matching liquid is a water based matching liquid.

Similarly, when the liquid composition of the acoustic matching liquid is mainly composed of water, surface concentration of a hydrophobic group of the annular portion 41 may be set lower than that of the peripheral portion 42, and thus the annular portion 41 has a higher hydrophilic property than that of the peripheral portion 42. Similarly, when the liquid composition of the acoustic matching liquid is mainly composed of water, surface concentration of a hydrate forming material of the peripheral portion 42 may be set lower than that of the annular portion 41, and thus the annular portion 41 has a higher hydrophilic property than that of the peripheral portion 42.

Unlike surface tension of a liquid, surface tension of a solid surface cannot be directly quantified, however, this issue can be solved by a Zisman plot method. The Zisman plot method is a method for regarding critical surface tension obtained from an intercept of cos θ=1 (a complete wetting state) as surface tension of a solid surface using plots obtained by performing contact angle measurement with respect to a focusing solid surface using different types of liquids. Surface tension of a solid surface can be identified by a Fowkes method, an Extended Fowkes method, and the like using a plurality of types of standard solutions as with the Zisman plot method.

Especially, in a final stage for discharging the acoustic matching liquid 2 from the liquid vessel 25, the liquid vessel 25 is configured to accelerate drainage of the acoustic matching liquid 2 from the peripheral portion 42 toward the annular portion 41 in the configuration according to the present exemplary embodiment.

In the above description, affinity control areas are two areas divided by the annular portion 41 and the peripheral portion 42, however, how to divide the area is not limited to this method, and the exemplary embodiment of the present disclosure includes methods using inclined distribution and stepwise inclined distribution of continuous surface energy.

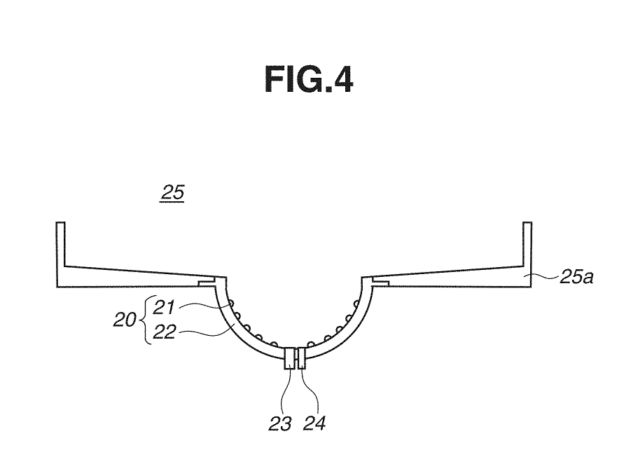

Further, a bottom of the peripheral portion 42 may be inclined to be lowered toward the annular portion 41 as a measure to accelerate the flow of the acoustic matching liquid 2 from the peripheral portion 42 to the annular portion 41. FIG. 4 is a cross-sectional view of a liquid vessel 25a including an inclined area in which a bottom of the peripheral portion 42 is inclined.

The annular portion 41 is an area for guiding the acoustic matching liquid 2 to the drainage port 24 to be drained, and a shape of the area viewed from above is not necessarily a circularly surrounding shape as illustrated in FIG. 2B. Further, it is not necessarily a hemispherical surrounding shape like the supporting member 22.

An exemplary embodiment of the acoustic wave receiving apparatus including the liquid vessel configured to accelerate drainage of the acoustic matching liquid is described below.

A second exemplary embodiment is configured to drain a residual acoustic matching liquid 2a from a peripheral portion 42 to an annular portion 41 by an external force other than surface tension.

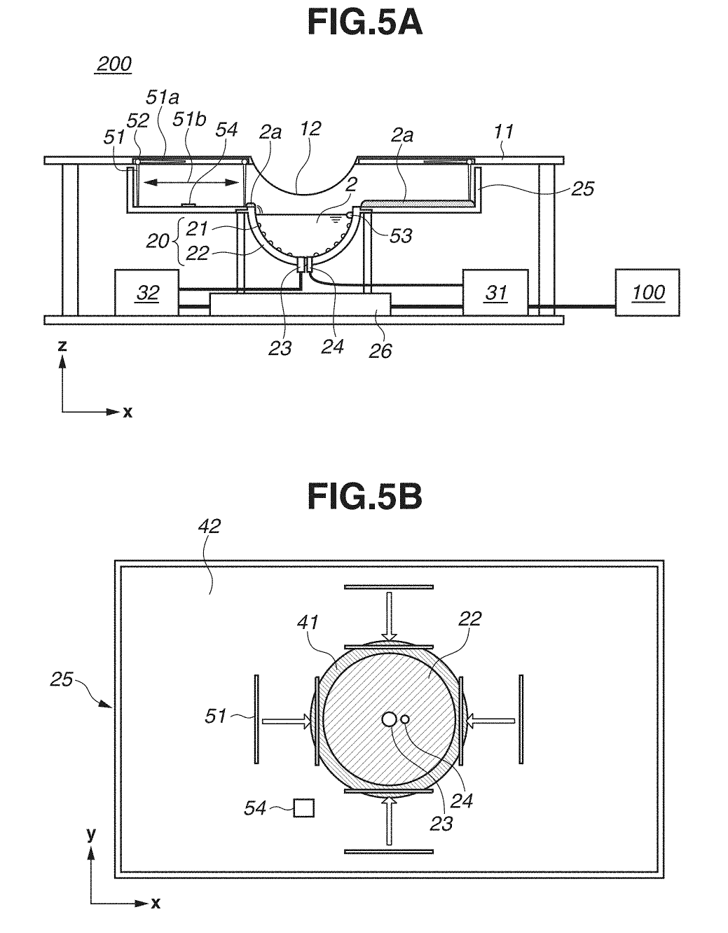

FIG. 5A is a cross-sectional view of an acoustic wave receiving apparatus 200 according to the second exemplary embodiment in which four wipers 51 capable of moving in a direction from the peripheral portion 42 to the annular portion 41 while sliding on an inner surface of a liquid vessel 25 are arranged in a circumferential direction, and FIG. 5B is a plan view illustrating a drainage mechanism of the liquid vessel 25.

The wipers 51 are coupled to the supporting unit 11 by a rotation supporting unit 52. A wiper 51a indicated by a dotted line represents a case in which the liquid vessel 25 is not wiped when the subject 1 is imaged, namely a storage state. When wiping is performed, the wipers 51 are rotated by the rotation supporting unit 52 and brought into a wipable state. The wipers 51 are formed by an elastic member and moved in a sliding state while sliding on the bottom of the peripheral portion 42 when wiping.

A moving mechanism of the wipers 51 is not illustrated, however, can be configured by a known technique which uses a motor as a power and moves the wipers 51 by a ball screw, a belt, or the like along a guide. Further, the wipers 51 are arranged to surround the liquid vessel 25, and each of the wipers 51 can be driven independently.

The configuration according to the present exemplary embodiment is provided with a liquid level sensor 53. The liquid level sensor 53 is a sensor which detects, when an operation unit 100 drains the acoustic matching liquid 2 in the liquid vessel 25, that the liquid vessel 25 becomes a state in which the acoustic matching liquid 2 in the liquid vessel 25 is drained lower than a predetermined lower limit value, and a wiping effect of the wipers 51 can be obtained.

A supply and drainage unit 31 can detect completion of drainage by a sensor not illustrated when the acoustic matching liquid 2 in the liquid vessel 25 and the receiving unit 20 is completely drained. However, wiping is not necessarily performed after the completion of drainage and can be performed while the acoustic matching liquid 2 is drained by the supply and drainage unit 31, and accordingly a time to complete the wiping can be shortened. Thus, if the acoustic snatching liquid 2 is stored nearly full in the annular portion 41 when the wipers 51 try to drain the residual acoustic matching liquid 2a to the annular portion 41, the acoustic matching liquid 2 cannot be drained from the peripheral portion 42 to the annular portion 41, so that it is configured to perform detection by the liquid level sensor 53. Initial positions of the wipers 51 and a position of the liquid vessel 25 are programed so that the wipers 51 and the liquid vessel 25 are in a predetermined start position relationship when wiping is started, and the wiping is started from these positions.

Further, according to the present exemplary embodiment, the liquid vessel 25 is provided with a wet sensor 54. The wet sensor 54 is a sensor which reacts when the residual acoustic matching liquid 2a remains a predetermined liquid amount or more inside the liquid vessel 25. Wiping driving is performed until the wet sensor 54 does not detect the residual acoustic matching liquid 2a, and thus the residual acoustic matching liquid 2a can be more surely drained. While the wiping is performed, the supply and drainage unit 31 continues driving for drainage. When the wet sensor 54 does not detect the residual acoustic matching liquid 2a, the wiping is completed, subsequently the supply and drainage unit 31 detects the completion of drainage, and the operation is completed.

The liquid level detection method that the liquid level sensor 53 detects the acoustic matching liquid 2 may be a method for calculating a liquid level of the acoustic matching liquid 2 in the liquid vessel 25 from a capacity of the liquid vessel 25 and a drainage amount per unit time by the supply and drainage unit 31.

A timing to start wiping may be not only by the above-described sequence but also a single driving by an operation of the operation unit 100.

The wiping method illustrated in FIGS. 5A and 5B is an example, and the number and a shape of the wipers, a moving direction, and a relative moving unit of the wipers are not limited to the above-described ones as long as drainage of the residual acoustic matching liquid 2a is accelerated from the peripheral portion 42 to the annular portion 41. When the number of the wipers is increased, a drainage time of the residual acoustic matching liquid 2a can be shortened. Further, when the shape of the wipers is formed in a shape similar to a circular arc of a wall surface of the liquid vessel 25, wiping of the residual acoustic matching liquid 2a can be more surely performed.

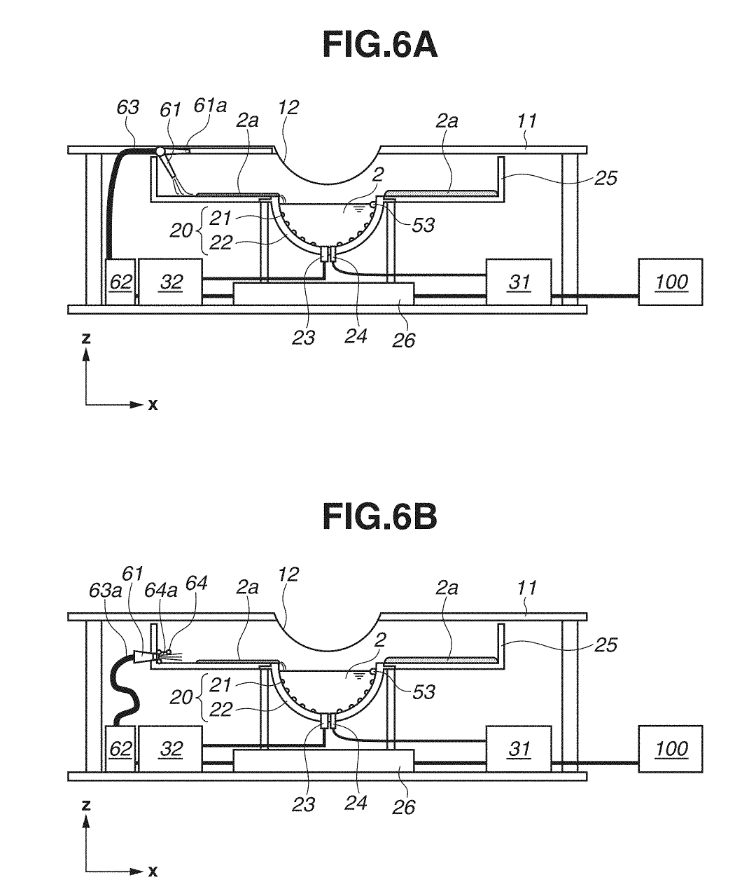

A third exemplary embodiment is configured to drain a residual acoustic matching liquid 2a from a peripheral portion 42 toward an annular portion 41 by an external force other than surface tension as with the second exemplary embodiment. An acoustic wave receiving apparatus 200 according to the present exemplary embodiment is different from the second exemplary embodiment in that a blower port 61 is provided instead of the wipers 51 as illustrated in FIGS. 6A and 6B.

The acoustic wave receiving apparatus 200 according to the third exemplary embodiment is described. FIGS. 6A and 6B illustrate a configuration provided with a blower unit. Acceleration of drainage by the blower unit is to forcibly drain the residual acoustic matching liquid 2a to the annular portion by blowing an air thereto. FIGS. 6A and 6B each illustrate an example of a different configuration of the blower unit. In FIG. 6A, the supporting unit 11 is provided with the blower port 61 for blowing an air as with the configuration of the above-described wipers. A blower port 61a indicated by a dotted line represents a storage state when the blower unit is not used. The blower port 61 is connected to an air pump 62 by a pipe 63. Drainage of the residual acoustic matching liquid 2a by the blower port 61 can sweep away the residual acoustic matching liquid 2a near the drainage port 24 by strength of air, and thus a drive of the blower port 61 is not configured in the present exemplary embodiment. However, a two-dimensional scanning stage 26 may scan the liquid vessel 25, and a driving mechanism of the blower port 61 may be separately provided without being limited to this configuration. The blower port 61 and the liquid vessel 25 are relatively driven, and the blower port 61 can be brought from the peripheral portion 42 to near the annular portion 41, so that the strength of air to be blown can be suppressed to be low. In addition, when the number of the blower ports 61 is increased, a drainage time of the residual acoustic matching liquid 2a can be shortened. A timing to drain the acoustic matching liquid 2 in the liquid vessel 25 by the blower port 61 is similar to the configuration example of the wiper. Further, the number and blowing directions of the blower ports 61, the presence or absence and a method of a moving unit are not limited to the above-described configuration.

FIG. 6B illustrates a configuration in which the blower unit is provided on the liquid vessel 25 side. In the configuration, the blower port 61 is water-tightly sealed by a blower port cover 64 when the blower unit is not used so that the acoustic matching liquid 2 does not enter the blower port 61 when the liquid vessel 25 is filled with the acoustic matching liquid 2. The blower port cover 64 indicated by a solid line in FIG. 6B represents an opened state and a state in which the blower unit can blow an air to the acoustic matching liquid 2. A blower port cover 64a indicated by a dotted line represents a closed state, and spaces of the liquid vessel 25 and the blower port 61 are water-tightly separated. A pipe 63a connecting the blower port 61 and the air pump 62 has a sufficient extra length so as not to be excessively pulled when the liquid vessel 25 is scanned. The liquid vessel 25 is provided with the blower unit, and thus a positional relationship between the liquid vessel 25 and the blower port 61 is always constant, so that the residual acoustic matching liquid 2a can be drained regardless of a position of the liquid vessel 25.

A heater for heating the liquid vessel 25 and evaporating the acoustic matching liquid 2 may be provided instead of the blower port 61.

A drainage acceleration unit according to a fourth exemplary embodiment vibrates a liquid vessel 25 to flow an acoustic matching liquid 2 from the liquid vessel 25 as a peripheral portion 42 to an annular portion 41.

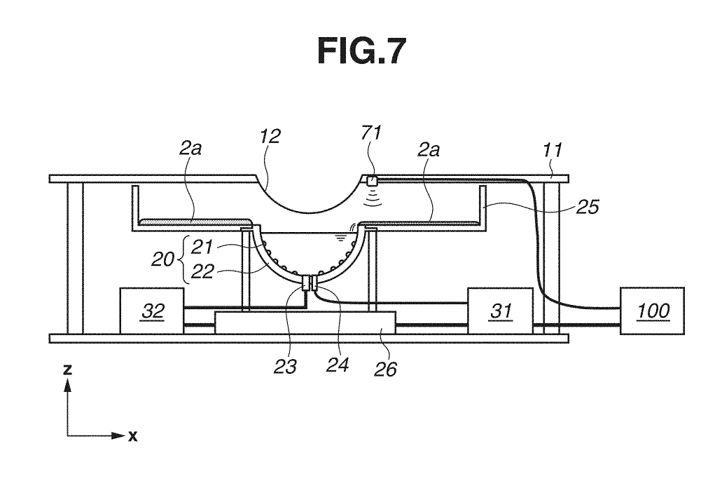

FIG. 7 is a configuration diagram in which a vibration mechanism 71 is provided as an example of a unit for vibrating. The vibration mechanism 71 is for vibrating by ultrasonic irradiation and disposed on a supporting unit 11. When the vibration mechanism 71 performs ultrasonic irradiation, a contact angle of a residual acoustic matching liquid 2a is reduced, and the residual acoustic matching liquid 2a easily flows from the peripheral portion 42 to the annular portion 41. The vibration mechanism 71 may be disposed on the liquid vessel 25 to vibrate the liquid vessel 25 and the residual acoustic matching liquid 2a. In addition, a mechanism for mechanically vibrating may be provided to vibrate the liquid vessel 25 and the residual acoustic matching liquid 2a without being limited to vibration by a sound wave. This configuration example is effective when the liquid vessel 25 and the receiving unit 20 are heavy in weight, and a load on the two-dimensional scanning stage 26 is large.

According to the above-described configuration, drainage of the acoustic matching liquid 2a from the liquid vessel 25 can be accelerated, and the acoustic matching liquid 2a remaining inside the liquid vessel 25 can be reduced.

The two-dimensional scanning stage 26 included in the acoustic wave receiving apparatus 200 according to the first exemplary embodiment illustrated in FIG. 1A may vibrate the liquid vessel 25 by a driving sequence instead of the vibration mechanism 71. For example, the liquid vessel 25 is reciprocated in an x direction or the y direction indicated in FIG. 1B, and thus the residual acoustic matching liquid 2a can be guided to the annular portion 41. A moving amount and acceleration and deceleration of reciprocation driving may be appropriately determined according to viscosity and surface tension of the acoustic matching liquid 2 which can be determined by large strokes and small strokes. The two-dimensional scanning stage 26 is used as described above, and thus it is not necessary to add a new mechanism. The driving direction is not limited to the linear reciprocation driving in the x direction or the y direction and may be linear driving in a combination of the x direction and the y direction or curve driving.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-167249, filed Aug. 31, 2017, which is hereby incorporated by reference herein in its entirety.

What is claimed is:

1. An acoustic wave receiving apparatus comprising:
a liquid vessel configured to store an acoustic matching liquid; and
a receiving unit configured to receive an acoustic wave from a subject via the acoustic matching liquid,
wherein the liquid vessel includes a drainage port configured to drain the acoustic matching liquid, an annular portion surrounding the drainage port, and a peripheral portion located outside the annular portion, and
wherein the liquid vessel is configured to accelerate drainage of the acoustic matching liquid from the peripheral portion toward the annular portion.

2. The acoustic wave receiving apparatus according to claim 1, wherein an affinity for the acoustic matching liquid of the annular portion is higher than that of the peripheral portion.

3. The acoustic wave receiving apparatus according to claim 1, wherein the acoustic matching liquid includes water, and the annular portion has a higher hydrophilic property than that of the peripheral portion.

4. The acoustic wave receiving apparatus according to claim 1, wherein a contact angle with respect to the acoustic matching liquid of the annular portion is smaller than that of the peripheral portion.

5. The acoustic wave receiving apparatus according to claim 1, wherein the peripheral portion includes an inclined area which becomes lower in a vertical direction toward the annular portion.

6. The acoustic wave receiving apparatus according to claim 1, further comprising at least one member selected from the group consisting of a wiper configured to be able to move in a direction from the peripheral portion toward the annular portion while sliding on an inner surface of the liquid vessel, a blower configured to blow an air from the peripheral portion toward a side of the annular portion, and a heater configured to heat the liquid vessel.

7. The acoustic wave receiving apparatus according to claim 1, wherein an area brought into contact with the acoustic matching liquid of the peripheral portion is larger than that of the annular portion.

8. The acoustic wave receiving apparatus according to claim 1, further comprising a wet sensor configured to detect the acoustic matching liquid of a predetermined liquid amount or more adhering to an inner surface of the liquid vessel.

9. The acoustic wave receiving apparatus according to claim 1, wherein the annular portion is a portion located overlapping with the receiving unit in a case where the liquid vessel is viewed from above in a vertical direction.

10. The acoustic wave receiving apparatus according to claim 1, wherein the receiving unit is an area in which a plurality of transducers is arranged in an array.

11. The acoustic wave receiving apparatus according to claim 10, wherein the annular portion is surrounded by the peripheral portion via an annular boundary, and the drainage port is disposed inside the annular boundary and in a non-arrangement area in which the transducers are not arranged.

12. The acoustic wave receiving apparatus according to claim 1, wherein the receiving unit is arranged in the liquid vessel so as to acoustically couple to a subject via a holding unit configured to hold the subject and the acoustic matching liquid stored in the liquid vessel.

13. The acoustic wave receiving apparatus according to claim 1, further comprising a light irradiation unit configured to irradiate the subject with light via the acoustic matching liquid to generate a photoacoustic wave.

14. The acoustic wave receiving apparatus according to claim 13, wherein the light irradiation unit is arranged on the annular portion.
